(19) United States
(12) Patent Application Publication
(10) Pub. No.: US 2018/0366767 A1
(43) Pub. Date: Dec. 20, 2018

(54) BIPOLAR BATTERY ELECTRICAL TERMINATION

(71) Applicant: Gridtential Energy, Inc., Santa Clara, CA (US)

(72) Inventors: Daniel Jason Moomaw, Santa Clara, CA (US); Collin Kwok Leung Mui, Mountain View, CA (US); Eduard Schummer, San Francisco, CA (US)

(21) Appl. No.: 16/112,455

(22) Filed: Aug. 24, 2018

Related U.S. Application Data
(63) Continuation-in-part of application No. PCT/US2017/019399, filed on Feb. 24, 2017.
(60) Provisional application No. 62/299,889, filed on Feb. 25, 2016.

(51) Int. Cl. H01M 10/04; H01M 2/24; H01M 10/18; H01M 2/26

(52) U.S. Cl. CPC H01M 10/0418; H01M 2/24; H01M 2004/029; H01M 2/26; H01M 10/18

(57) ABSTRACT

An end contact, such as for a bipolar battery assembly, can be sized and shaped to provide a low resistance electrical bond between the battery cells and a terminal. In an example, a bipolar battery assembly can include a casing, at least one bipolar current collector housed within the casing, a first monopolar current collector, a first electrolyte region defined between the bipolar current collector and the monopolar current collector, and a first electrically-conductive end contact electrically coupled to the first monopolar current collector. The first electrically-conductive end contact can include a centrally-located hub region, a plurality of planar arms extending radially outward from a centrally-located hub region, and at least one planar brace comprising a first segment extending between two planar arms amongst the plurality of planar arms. A similar end contact can be used for opposite end of the battery assembly.

### CLAIM OF PRIORITY

This patent application is Continuation-in-Part and claims benefit of Moomaw et al., International Patent Application Serial Number PCT/US2017/019399, titled “BIPOLAR BATTERY ELECTRICAL TERMINATION,” filed Feb. 24, 2017 (Attorney Docket No. 3601.022WO1), which claims the benefit of priority of Moomaw et al., U.S. Provisional Patent Application Ser. No. 62/299,889, titled “Optimized Bipolar Battery Electrical Termination,” filed on Feb. 25, 2016 (Attorney Docket No. 3601.022PRV), the benefit of each of which is hereby presently claimed, and the entirety of each of which is hereby incorporated by reference herein.

### BACKGROUND

Bipolar batteries are generally considered to provide a simple and direct current path through the battery. Unlike other battery configurations, in a bipolar battery, electrical charge generally moves serially through the bipolar battery from one terminal to the next. Parallel connections are not required and current is not required to traverse a complicated path. Accordingly, a bipolar battery configuration can provide low internal resistance, which enables bipolar batteries to deliver high power efficiently.

### OVERVIEW

The present inventors have recognized, among other things, that it has proven difficult in the past to leverage an internal low resistance property of a bipolar battery configuration at least in part because the “ends” of a stack of bipolar current collectors still contribute to a total path resistance. Accordingly, an ongoing technical problem exists in collecting current and transferring it to terminals or lugs of a battery assembly, including one or more of reducing or minimizing resistive loss, providing strength for the battery assembly, controlling a weight of the battery assembly, and providing for terminal and housing configurations of varying size.

In one approach, an end contact, such as for a bipolar battery assembly, can be sized and shaped to provide a low resistance electrical bond between the battery cells and a terminal. Such an end contact can also be sized and shaped so that its weight or mass does not become a burden in an otherwise space-efficient and lightweight battery assembly.

In an example, a bipolar battery assembly can include a casing, at least one bipolar current collector housed within the casing, a first monopolar current collector, a first electrolyte region defined between the bipolar current collector and the monopolar current collector, and a first electrically-conductive end contact electrically coupled to the first monopolar current collector. The first electrically-conductive end contact can include a centrally-located hub region, a plurality of planar arms extending radially outward from a centrally-located hub region, and at least one planar brace comprising a first segment extending between two planar arms amongst the plurality of planar arms. A similar end contact can be used for opposite end of the battery assembly.

In an example, a method, such as for fabricating an end contact, can include forming an electrically-conductive end contact, the method comprising forming a centrally-located hub region, forming a plurality of planar arms extending radially outward from a centrally-located hub region, and forming at least one planar brace comprising a first segment extending between two planar arms amongst the plurality of planar arms.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A illustrates generally a section view of an example that can include a bipolar battery assembly and at least one end contact.

FIG. 1B illustrates generally a section view of another example that can include a bipolar battery assembly and at least one end contact, such as having a terminal configuration differing from the example of FIG. 1A.

FIG. 2A illustrates generally an isometric view of an example including an electrical end contact, such as can include a centrally-located hub and planar arms arranged in an “X” pattern, along with respective braces connecting the arms to one another, such as at their midsections.

FIG. 2B illustrates generally a view of another example of an end contact configuration, similar to FIG. 2A, but having top-mounted lug attached to the plate at the end of one of the planar arms.

FIG. 3 illustrates generally a section view of an end-plate assembly, such as for bipolar battery, including an end contact.

FIG. 4 illustrates generally an illustrative example including a stress simulation of an end contact when 120 kiloPascals (kPa) of simulated compressive force is applied to the end monopole assembly.

FIG. 5 illustrates generally an illustrative example of a current flow simulation (and a resulting current density) of an end contact assuming a 24 Volt (V) battery exhibiting an 18 Ampere (A) discharge current.

FIG. 6 illustrates generally an illustrative example including a stress simulation of a higher-mass end contact when 120 kiloPascals (kPa) of simulated compressive force is applied to the end monopole assembly.

FIG. 7 illustrates generally an illustrative example of a current flow simulation (and a resulting current density) of a higher-mass end contact assuming a 24 Volt (V) battery exhibiting an 18 Ampere (A) discharge current.

FIG. 8 illustrates generally an illustrative example including a stress simulation of an end contact having the brace structures removed as compared to the example of FIG. 2A, with such a stress simulation including 120 kiloPascals (kPa) of simulated compressive force applied to the end monopole assembly.

FIG. 9 illustrates generally an illustrative example of a current flow simulation (and a resulting current density) of the end contact configuration shown in FIG. 8, assuming a 24 Volt (V) battery exhibiting an 18 Ampere (A) discharge current.

FIG. 10 illustrates generally an isometric view of an example including an electrical end contact having additional bracing segments for enhanced rigidity as compared to the example of FIG. 2A.

FIG. 11 illustrates generally an illustrative example of a current flow simulation (and a resulting current density) of the end contact configuration shown in FIG. 10, assuming a 24 Volt (V) battery exhibiting an 18 Ampere (A) discharge current.

FIG. 12 illustrates generally a technique, such as a method, that can include forming a current collector, coupling an end electrode to the current collector, and securing the current collector to a casing segment.

FIG. 13 illustrates generally an isometric view of an example including an electrical end contact, such as can include a centrally-located hub region and planar arms extending radially outward from the hub region.

FIG. 14 illustrates generally an illustrative example including a stress simulation of an end contact having a structure as shown generally in FIG. 13.

### DETAILED DESCRIPTION

In various applications, energy storage solutions are specified to operate under constant or nearly-constant high-power-delivery conditions. Such applications include battery-powered or hybrid electric vehicles. Other applications include storage facilitates for frequency regulation, load shifting, and other similar applications where large current outputs from batteries are demanded over relatively short time scales. In order to meet harsh demands for such applications, an energy storage solution can benefit from lower internal resistance as compared to generally-available battery technologies. High resistance generally creates a large voltage drops and can also result in generation of excess waste heat. The voltage drop alone can be detrimental to many power systems because electric motors and inverters often specify a minimum voltage to function properly. A battery that drops below the specified voltage when delivering its charge may provide little use. Furthermore, for storage chemistries that rely on chemical reactions, such as lead-acid, a steep voltage drop can increase aging that can ultimately lead to premature battery failure. The generation of waste heat can also cause operational complexities.

A variety of different storage configurations may be vulnerable to thermal runaway under certain circumstances. High internal temperature can trigger such thermal runaway. Accordingly, the present inventors have recognized that a likelihood of thermal runaway can be reduced such as by controlling an increase in internal battery temperature under heavy load. As mentioned above, a bipolar battery configuration can provide simplicity including a short current path that enables low internal resistance for the battery overall. As such, for high power applications bipolar batteries can provide similar power output as compared to other approaches, but having less of an increase in internal battery temperature.

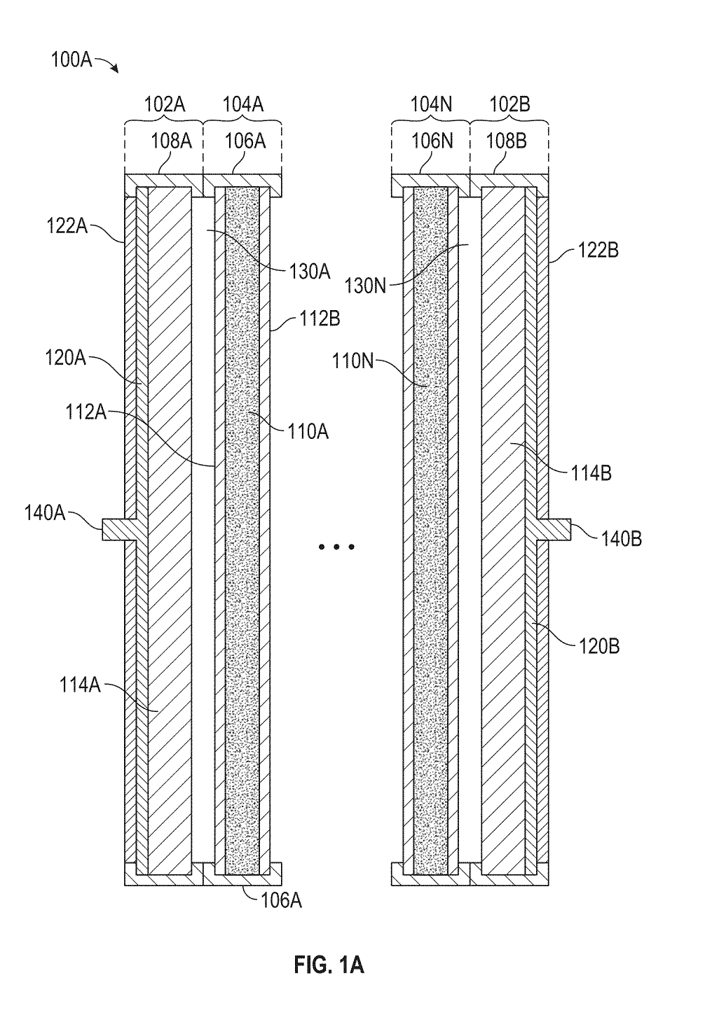

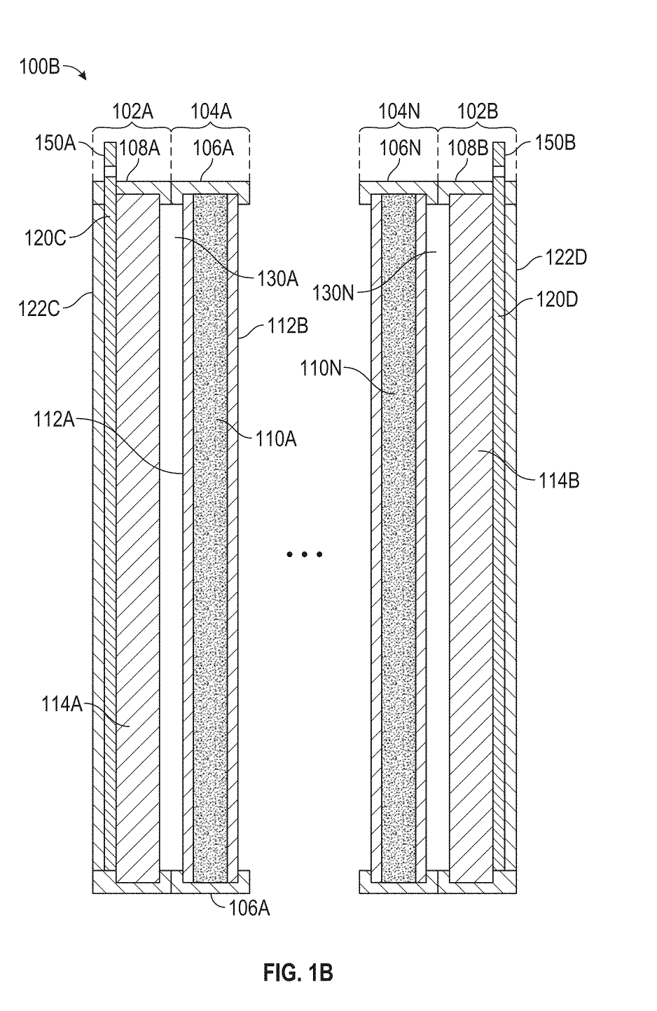

FIG. 1A illustrates generally a section view of an example that can include a bipolar battery assembly 100A and at least one end contact, such as an end contact 120A or an end contact 120B. In the example of FIG. 1A, the bipolar battery assembly 100A can include a modular configuration, such as having one or more bipolar current collectors (e.g., a first current collector 110A and an “Nth” current collector 110N). The bipolar current collectors can include a conductive substrate, such as a substrate including silicon. For example, one or more of a semiconductor grade or metallurgical grade silicon can be used as a substrate for a bipolar current collector 110A or 110N. The silicon can be monocrystalline or multicrystalline, for example. The silicon can be doped to provide a specified bulk resistivity, such as including an n-type dopant. One or more surfaces of the bipolar current collector 110A or 110N can be treated, such as to one or more of enhance electrically conduction between the substrate and other elements in the battery assembly 100A, or to passivate the substrate surface for compatibility with the battery assembly 100A chemistry. In an example, an ohmic contact layer 112A or 112B can be formed on the substrate, such as can include a silicide. Such a silicide can include a metal species such as nickel, cobalt, titanium, tantalum, tungsten, molybdenum, combinations thereof, or one or more other materials. For example, the substrate can be formed, and can then a metal can be deposited or coated upon the substrate. The substrate can then be annealed with the deposited or coated metal to form a silicide. An active material, such as a lead paste or lead oxide paste can be applied to the ohmic contact layers 112A or 112B, such as providing a cathode on one surface of the bipolar current collector 110A and an anode on an opposite surface of the bipolar current collector 110A.

The bipolar current collector 110A can be mechanically coupled to a casing segment 106A, such as to provide a protective mechanical support around the perimeter of the bipolar current collector 110A. Such coupling can include use of one or more of plastic welding, overmolding, adhesives, flexible seals, or flexible gaskets. Other bipolar current collectors, such as the “Nth” current collector 110N can similarly be mechanically coupled to a corresponding casing segment, such as the segment 106N. The casing segments can be arranged to interlock or to be bonded together to form a hermetically-sealed assembly. Alternatively, or in addition, the casing segments can be overmolded or assembled within a larger housing. A total count of bipolar current collectors can be specified to provide a desired number of cells to achieve a specified overall output voltage for the battery assembly 100A. Regions between adjacent current collectors can be defined, such as a region 130A or a region 130N. Such regions can be hermetically sealed from the surroundings of the battery assembly 100A, and from each other, such as to provide a space for a liquid, gel, or solid electrolyte. As an illustrative example, an absorbed glass mat can be placed in each of the electrolyte regions 130A through 130N.

The end current collectors in the bipolar battery assembly 100A can include monopole structures 114A and 114B, such as having only an anodic or cathodic active material on their interior-facing side. The monopolar structures can also include a substrate such as a silicon wafer, similar to the bipolar current collectors 110A through 110N. Alternatively, the monopolar structures 114A and 114B can be made from another material, such as a plastic or metallic grid supporting the active material. An end contact 120A can be placed on a face of the monopolar structure 114A opposite the interior of the battery assembly 100A. For example, the monopolar structure 114A can include an end casing segment 102A having a configuration similar to, or different from, the casing segment 104A used for a bipolar current collector 110A. An end cap element 122A can be used, either integral to the end casing segment 102A, or mechanically coupled to the end casing segment 102A such as using a mechanical flange, adhesive, welding, or one or more other techniques. The end cap element 122A can define an aperture or other opening such as to expose a portion of the end contact, such as the terminal 140A, and similarly the end cap element 122B can define another aperture or other opening such as to expose a portion of the end contact 120B, such as the terminal 140B. The casing portions such as the end cap element 122A, end casing segment 102A, and casing segment 102A can be formed from a thermoplastic or thermosetting polymer material, and can include one or more of a variety of materials such as acrylonitrile butadiene styrene (ABS).

An electrical interconnection to the battery assembly 100A can include use of one or more terminals such as a terminal 140A and a terminal 140B located upon or included as a portion of the end contact 120A and the end contact 120B, respectively. In the illustrative example of FIG. 1A, the terminals 140A and 140B are shown as protruding outward in a direction perpendicular to the current collectors 114A, 110A, 110N, and 114B. One or more of the end contact 120A or the end contact 120B can include a mechanical configuration or can be fabricated according to various examples shown and described herein, below.

Other terminal 140A or 140B configurations can be used. For example, FIG. 1B illustrates generally a variation of a bipolar battery assembly 100B, such as similar to FIG. 1A, having one or more bipolar current collectors 110A through 110N, where the bipolar current collector 110A, as an example, can include one or more ohmic contact layers 112A or 112B, along with regions 130A through 130N defined by respective gaps between the current collectors. As in FIG. 1A, the bipolar battery assembly 100B can include one or more monopolar structure 114A or 114B. A housing for the bipolar battery assembly 100B can include casing segments 106A through 106N, along with end casing segments 102A and 102B, coupled to or integrally fabricated to include end caps 122C and 122D.

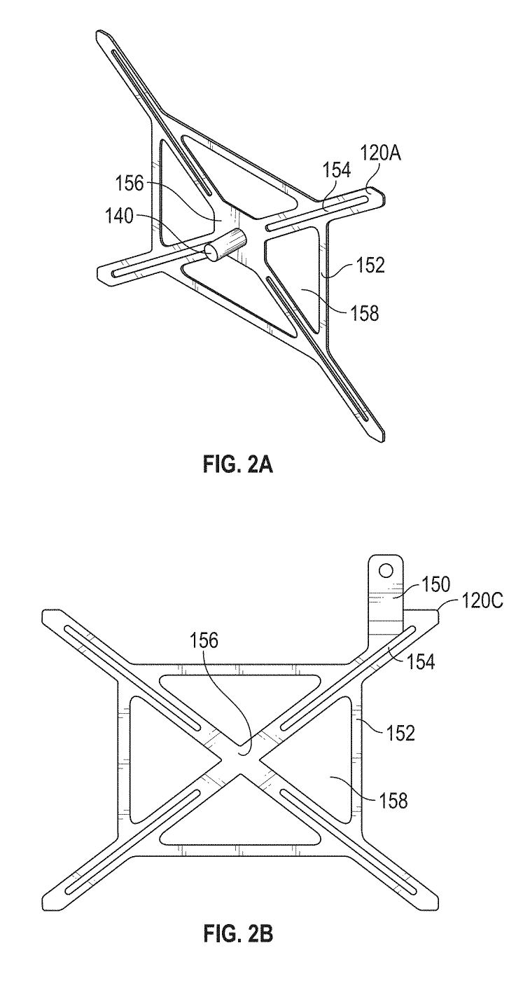

By contrast with the example of FIG. 1A, the example shown in FIG. 1B can include end contacts 120C and 120D coupled to or including terminals 150A and 150B, respectively, such as corresponding to the terminal configuration 150 shown illustratively in FIG. 2B. The remainder of the end contacts 120C and 120D can include features or structure similar to other end contact examples described herein. For example, the terminals 150A and 150B can be arranged or located to conform to a certain specified battery geometry, such as conforming to a U-designation (e.g., “U1”) as specified by Battery Council International (BCI). Generally, the bipolar current collectors 110A and related surface treatments such as the layer 112A or 112B as shown in FIG. 1A and FIG. 1B can be referred to as “bipolar plates,” bipoles,” or “biplates,” and the corresponding monopolar structures 114A and 114B can be referred to as “monopolar plates” or “monopoles,” or “monoplates.”

To control total path resistance, various resistive elements within a bipolar battery assembly 100A or 100B can be sized or shaped to reduce a resistance contribution. Contributions to internal resistance come from various sources. Bipolar batteries eliminate some trouble areas as compared to other approaches, but a bipolar configuration can also introduce new sources of increased resistance. A termination of one or more series-connected stacks of cells within a bipolar battery can create additional series resistance. In generally-available monopolar batteries, regardless of chemistry, the current collectors are generally fitted with a tab that extends outside of the cell to enable parallel or series connections within the overall battery packaging. With bipolar batteries each current collector can be isolated from other elements of the battery (such as by casing segments as shown illustratively in FIG. 1A and FIG. 1B) and therefore the current collectors in a bipolar battery do not generally feature such tabs.

In one approach, bipolar stacks feature a collection of bipoles with one monopole bounding either end as in FIG. 1A and FIG. 1B. The end monopoles are generally configured to collect current from the stack and transfer it to the standardized lugs or other terminals accessible from the outside of the battery packaging. Inefficiencies or failures relating to the end monopole can have dramatic impact on battery performance overall, particularly with regard to resistance. A poorly-arranged contact or other interconnection between the end monopole and the battery lug can hurt overall power performance or can lead to significant heat buildup. Densely packaged bipolar batteries may have difficulty efficiently dissipating such heat buildup.

For this reason, an end contact to a bipolar battery stack can be used to control a significant proportion of internal resistance. Factors such as impedance of the biplate material or the quality of the contact between the active material and the biplates, and can vary considerably depending on battery chemistry. In one approach, an end monopole can interface with a large metallic sheet having roughly the same dimensions as the monopole. This sheet is formed into a battery terminal on the opposing edge that protrudes out from the battery end cap. Based on a composition of the monopole itself (such as where the monopole is a polymer material), a sheet can be mechanically compressed against it. A similar approach can be used in the example of a zinc bipolar battery. For example, a thin metallic sheet can be adhered to the end monopole in much the same way that the active material would be adhered to the bipoles. Defined as an accumulator sheet, the sheet can interface with an additional terminal piece that passes through the plastic casing to the exterior. The terminal post can be bonded to the accumulator sheet.

The use of a large area metal plate for an end contact can provide two notable advantages: large current collecting ability for low resistance and high thermal absorption for efficient heat transfer assuming the end plate is designed to maximize that feature. However, this type of contact can be heavier or more expensive to manufacture due to material costs. Furthermore, achieving a reliable and low resistance bond between a solid monopole and a solid end contact can be difficult. Bonding generally only occurs around the perimeter, leaving the possibility for contact resistance to build up near the center of the plates due to non-uniform bonding. Such buildup can cause uneven current flow through the end monopole, which could affect the bipolar stack overall.

In another approach, the end monopole can be eliminated altogether. More specifically, the end contact, the terminal, and the end monopole can be combined into a single component. This eliminates potentially unreliable bonds and decreases overall mass by eliminating duplicating features. However, a single solid block at the end of each battery can create corrosion concerns for acidic chemistries. In order to combat this, the monopole-contact block can be thickened to account for gradual degradation throughout the battery life. But, such thickening can eliminate an advantage of reduced mass. Furthermore, constructing the end contact parts out of a different material from the biplates creates the possibility of unpredictable failure modes within the battery. The many attempts at establishing low-resistance end contact for bipolar batteries contribute various ideas, but the present inventors have recognized that a better solution is still needed to meet the high-power demands of modern electrical systems.

The present inventors have proposed a method of establishing end contact to enable high current carrying ability with low mass, such as using one or more of the end contact configurations described herein. Such a conductive end contact can be mated to end monopoles of a battery stack, such as directly. Using dedicated current collectors for one or more of the bipoles and monopoles allows for a lightweight and rigid system. For example, the biplate material can be selected for mechanical robustness, corrosion resistance, and light weight. Leveraging such characteristics for each cell of a battery assembly creates a high-performing bipolar battery overall. The electrical end contact can then be used to collect current and transfer it to the battery terminals or lugs. The shape of an end contact is not a trivial concern. The end contact is generally specified to provide a highly conductive material with minimal resistive drop. The end contact is configured for rigidity to support the end monopoles because generally, bipolar batteries are highly compressed. The weight of the end contacts can be constrained to allow the battery stack to attain a high specified gravimetric energy density. The volume of the plate is also generally constrained to reduce bulk and preserve volumetric energy density of the battery. Fulfilling these objectives can be achieved using various end contact configurations each with advantages, but the configurations described herein was found to be relatively superior when tested against various objectives such as those mentioned above.

Many end contact shapes were explored by the present inventors, and generally a cruciform or X-shape was found to be relatively better than other configurations, such as due to its ability to cover a large percentage of a rectangular area while still providing reduced volume as compared to a solid end contact. Bipolar batteries generally benefit when a uniform current density is established throughout their volume. An end electrical contact method that does not cover a large proportion of the end monopole area creates a current path that travels both parallel and perpendicularly to the current collectors. This complicates the current path and results in a larger source resistance. A larger covered area also generally provides more structural support for the battery, thus resulting in a more robust system overall. While a simple cruciform or “X” shape can provide advantages, the present inventors suggest that those advantages can be enhanced by one or more of providing bracing between the arms of the “X” shape or providing apertures defined by portions of the arms defining an “X” shape as shown illustratively in the examples of FIG. 2A and FIG. 2B. The mass penalty for additional material for bracing can be minimal, but the increased covered surface area of the monopole results in further improved strength and current-carrying properties.

FIG. 2A illustrates generally an isometric view of an example including an electrical end contact 120A, such as can include a centrally-located hub region 156 and planar arms arranged in an “X” pattern, along with respective braces, such as a brace 152 connecting the arms to one another, such as at their midsections. The arms can define elongate apertures, such as an aperture 154, extending distally from the centrally-located hub region 156. Such apertures or “cutouts” can be used, such as to facilitate attachment of the end contact 120A to a monopole. Larger apertures such as an aperture 158 can be defined by a combination of adjacent arms and a brace 152.

As an illustrative example, a center of the “X” shape can include a metal feature protruding out in a direction perpendicular to the monopole as shown illustratively in FIG. 2A to serve as a terminal 140. The feature can extend through the battery end cap and act as one terminal 140 for the battery. The terminal 140 can be configured to provide or mate with lug shapes generally specified in the marketplace. The end contact 120A can be configured or can otherwise define a number of through-holes, such as to facilitate attachment of the plate to the end monopole. Attachment can be achieved using various electrically conductive bonds. For example, if the end monopole features a metallic strike layer, the end contact 120A can be welded to the monopole. The relative simplicity of this assembly technique combined with the ease of manufacturing an X-brace (such as using cold stamping) can provide a low cost, yet robust solution.

FIG. 2B illustrates generally a view of another example of an end contact 120C configuration, similar to FIG. 2A, but having top-mounted lug attached to the plate at the end of one of the planar arms to serve as a terminal 150. The lug terminal 150 can include one of many different form factors depending on battery application and size class. The illustrative example shown in FIG. 2 corresponds to BCI U1, according to group sizes established by Battery Council International (BCI). As in FIG. 2A, the end contact 120C can include a plurality of planar arms extending distally from a centrally-located hub 156, such as having one or more arms defining an elongate aperture 154. One or more braces such as a brace 152 can bridge adjacent arms, defining another aperture 158.

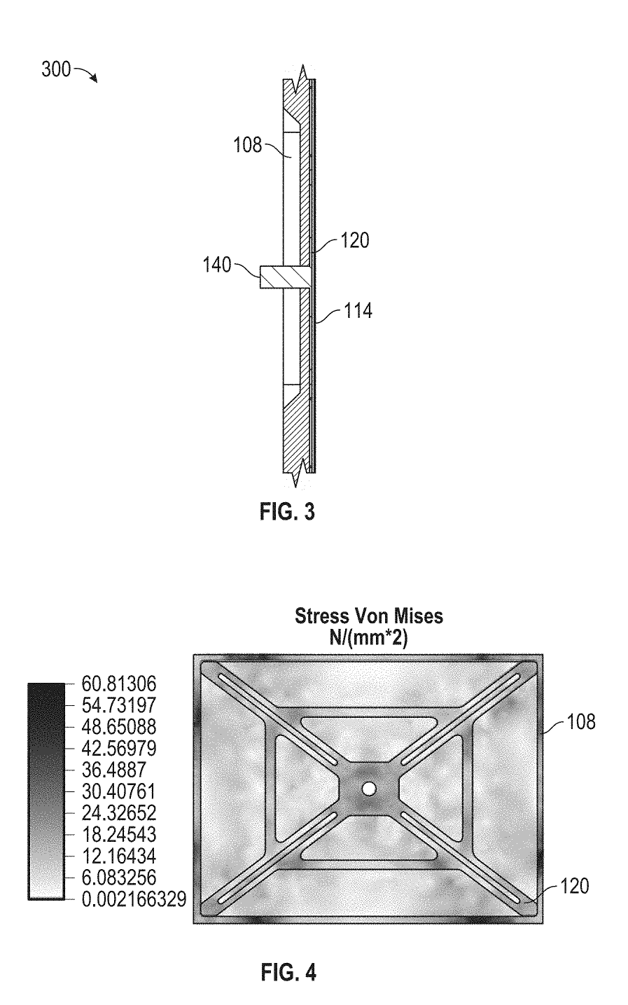

FIG. 3 illustrates generally a section view of an end-plate assembly 300, such as for bipolar battery, including an end contact 120. As in the other examples described herein, the end contact 120 can include a variety of configurations such as an “X” pattern. As shown illustratively in FIG. 3, the end contact 120 can be compressed between the end monopole 114 of the battery assembly and a portion of the casing 108, such as plastic end cap. In this example, the end cap of the casing 108 features a hollowed-out section around its center, such as to facilitate easy access to the side-mounted terminal 140.

FIG. 4 illustrates generally an illustrative example including a stress simulation of an end contact 120 when 120 kiloPascals (kPa) of simulated compressive force is applied to the end monopole assembly, the assembly including a casing 108 and the end contact 120 abutting the monopole. A relatively uniform stress distribution is shown having a peak stress of around 60 Newtons per square millimeter (or megaPascal (MPa)), illustrating that the end contact 120 need not be a solid plate but can instead include a “X” shape, such as having stiffening braces between respective arms defining the “X” shape, providing mass savings while still maintaining rigidity as compared to a solid end contact.

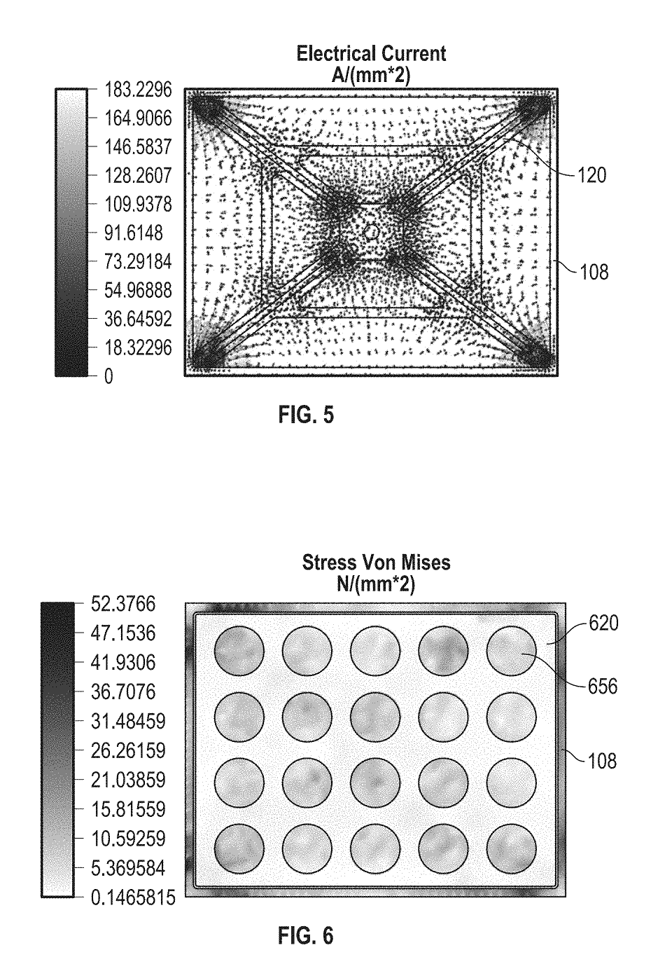

FIG. 5 illustrates generally an illustrative example of a current flow simulation (and a resulting current density) of an end contact 120 assuming a 24 Volt (V) battery exhibiting an 18 Ampere (A) discharge current. As mentioned elsewhere herein, bipolar batteries can leverage a highly uniform current distribution to prolong battery life, but in order for this to occur, the current should be directed to flow cleanly through the terminal, through the end contact, and through the cells. This can be facilitated by a contact plate that extends to the edges of the current collectors towards the casing 108. This allows electrons to move perpendicular to general battery flow within the contact plate, which is highly conductive, rather than through the monopole which is often less conductive. In the vector plot of FIG. 5, the current direction arrows in the regions outside the end contact conductor are shown pointing uniformly toward the conductive end contact.

FIG. 6 illustrates generally an illustrative example including a stress simulation of a higher-mass end contact 620 when 120 kiloPascals (kPa) of simulated compressive force is applied to the end monopole assembly, the assembly including the casing 108 and a monopole. The end contact 620 is simplified as compared to the other examples described herein. To reach the edges of the active material within the battery, a reduced mass end contact can be provided using a solid plate with 20 circular holes 656 removed. At a thickness of 1 mm, the end contact 620 shows excellent strength properties and electrical properties. FIG. 6 illustrates generally that under a 120 kPa load, the amount of stress present in the end monopole was just 52 MPa and total deflection was tens of microns.

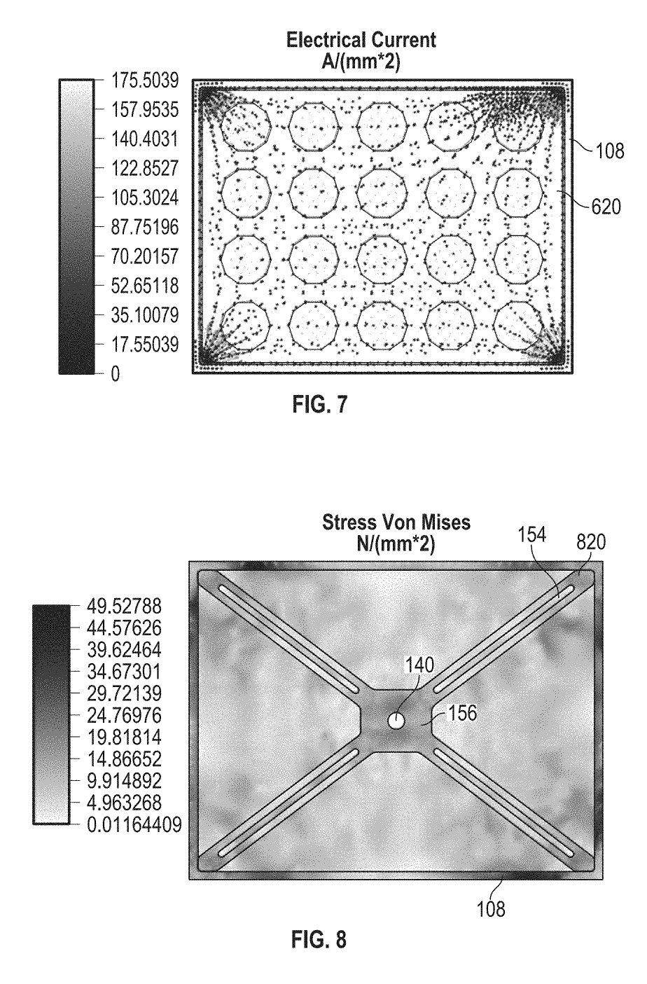

FIG. 7 illustrates generally an illustrative example of a current flow simulation (and a resulting current density) of a higher-mass end contact 620 assuming a 24 Volt (V) battery exhibiting an 18 Ampere (A) discharge current, bounded by a casing 108. The vector plot of FIG. 7 illustrates generally that the vectors are pointing straight up from the monopole into the contact 620, suggesting a short (e.g., non-meandering) current path. Additionally, a total current was estimated to be about 175 Amperes per millimeter squared (A/mm²) assuming a 24V battery and 18 A of load, thus generating just 9 microOhms (μΩ) of resistive loss at the contact. Despite these performance advantages, the example 620 of FIG. 6 and FIG. 7 is heavier than other examples described herein (such as examples including an “X” arm configuration). Depending on overall battery size, an end contact having the shape shown in FIG. 6 or FIG. 7 could contribute up to 5% of total mass. Accordingly, the other configurations shown herein can be used when further weight reduction is desired.

FIG. 8 illustrates generally an illustrative example including a stress simulation of a simplified end contact 820 having the brace structures removed as compared to the example 120 of FIG. 4, with such a stress simulation including 120 kiloPascals (kPa) of simulated compressive force applied to the end monopole assembly. The end contact 820 can be housed inside a casing 108, such as having a centrally-located hub 156, a terminal 140, and one or more elongate apertures such as an aperture 154.

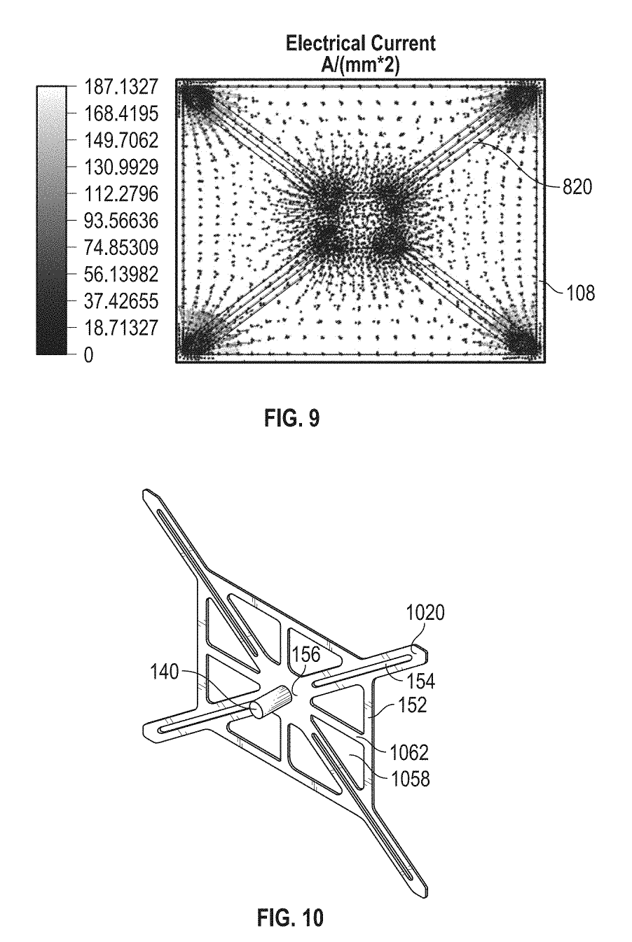

The X-shape shown in FIG. 8 includes features to reach the edges of the active material section of the monopole while removing weight as compared to the example of the end contact 620 of FIG. 6. As an illustrative example, a total mass contribution of the end contacts dropped to less than 1% when the end contact 820 of FIG. 8 is used. A considerable loss in structural integrity is observed, by comparison. In this example, a total resultant stress in the end monopole dropped to 49 MPa with a 120 kPa load primarily due to fewer contact points. The displacement increased to over 200 micrometers (μm). Such displacement may be undesirable for some applications. A similar loss of performance was observed in the current flow simulation vector plot, shown in FIG. 9, which illustrates generally an illustrative example of a current flow simulation (and a resulting current density) of the end contact 820 configuration shown in FIG. 8, assuming a 24 Volt (V) battery exhibiting an 18 Ampere (A) discharge current.

By contrast with the configuration of the end contact 820 shown in FIG. 8 and FIG. 9, the end contact 120 shown in FIG. 4 can include planar bracing or “ribs” placed between the extended planar arms, where the planar arms form an “X” shape. Using the connecting ribs, mechanical loads can be better distributed and therefore greater rigidity can be achieved in comparison examples lacking the rib structure. A mass penalty for inclusion of the ribs is small. The application of a 120 kPa load to the monopole resulted in 60 MPa of stress, as seen in the illustrative example of FIG. 4, as compared to the 49 MPa shown in FIG. 8. The stresses mentioned above are acceptable for a broad range of monopole materials. Furthermore, the higher 60 MPa stress resulted in only about 100 micrometers (μm) of deflection in the structural configuration shown in FIG. 2A, a value unlikely to cause failure in a monopole.

Inclusion of ribs or bracing structures can provide an improvement in resistance (e.g., a lowering of series resistance). Referring back to FIG. 5, the vector plot indicates superior performance of the end contact 120 including bracing as compared to the simplified X-plate configuration of the end contact 820 of FIG. 8, but slightly inferior to the more-solid plate configuration of the end contact 620 of FIG. 6. As an illustrative example, the end contact 120 of FIG. 5 can provide a series resistance contribution of about 14μΩ, which can be regarded as acceptable for a variety of high-power applications.

Adding more segments to one or more of the bracing structures can enhance stress performance or help to improve resistance. For example, additional bracing can better distribute current flow throughout the plate, suggesting better power performance under even higher currents. FIG. 10 illustrates generally an isometric view of an example including an electrical end contact 1020 having additional bracing segments (such as a segment 1062 extending from a brace 152), to provide enhanced rigidity as compared to the example 120 of FIG. 4. The end contact 1020 can be similar, otherwise, such as including a centrally-located hub 156, a terminal 140, and one or more apertures such as an elongate aperture 154 or other aperture 1058, with arms extending towards a periphery defined by a casing 108.

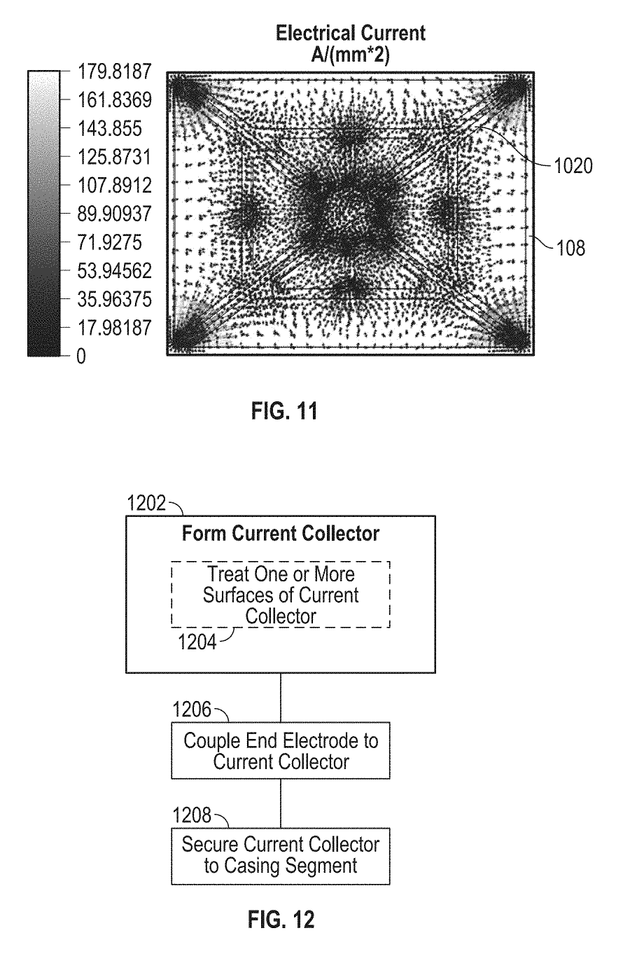

In the example of FIG. 10, mid-point segments are connected back to the central rectangular feature (e.g., the hub 156). Mechanical simulation showed no tangible differences in structural performance for the additional material. The electrical properties were improved, as shown in FIG. 11, which illustrates generally an illustrative example of a current flow simulation (and a resulting current density) of the end contact 1020 configuration shown in FIG. 10, assuming a 24 Volt (V) battery exhibiting an 18 Ampere (A) discharge current. When simulated in a configuration corresponding to a 24V battery with an 18 A discharge current, the resistance was found to be 13μΩ. This slight decrease as compared to the example of FIG. 5 may not be sufficient to justify the added complexity of manufacturing.

The various examples of end contact configurations described herein were thermally tested to gain an understanding of their ability to maintain thermal stability in the application of a 24V U1 form-factor bipolar battery. Regardless of configuration, battery temperature was well-controlled when the plate was fabricated using a highly-thermally conductive metal. In most cases waste heat is evacuated from a battery through its sides, rather than through the end caps. Nevertheless, utilizing a metallic end contact with sufficient thermal mass can provide further stability for the system overall.

FIG. 12 illustrates generally a technique, such as a method, that can include forming a current collector at 1202, coupling an end electrode to the current collector at 1206, and securing the current collector to a casing segment at 1208. Forming the current collector can include operations such as one or more of molding, etching, or stamping the current collector. If a silicon current collector is used, the silicon can be molded or grown in crystalline form and sawed into wafers. One or more surfaces of the current collector can be treated, such as to include one or more of an ohmic contact layer or adhesion layer. The ohmic contact layer can include a silicide, as mentioned elsewhere herein.

At 1206, a technique for securing (e.g., bonding) the end contact to the end monopole can also contribute to the performance of the end contact. For example, an elongate aperture can be formed in the planar arms, as mentioned in relation to various examples herein. This elongate aperture creates a channel for welding or soldering to occur if the monopole is metallic or covered in a metallic film. For examples where a metallic or metal-film-clad end contact is not used, the channel can be used to house one or more fasteners to facilitate forced contact. Additionally, bonding can occur around the perimeter of the plate if the integrity of the channel-only bonds is deemed somehow insufficient for the stress cycle in a particular battery application. A wide variety of techniques can be used to secure the end contact to an end plate of the battery assembly.

For example, a solder (e.g., silver, tin-lead, or other solder) can be used to bond the end contact to a metallized or conductive portion of the battery plate, such as along a portion or an entirety of a length of the planar arms of the end contact. As an illustrative example, a solder bead can be applied with automated equipment or by hand. In another approach (or in addition), a thin lead-tin or other solder sheet that can be reflowed over or under the end contact. In yet another approach, a conductive epoxy can be applied to an interface between the end contact and a metallization layer of the metallized or conductive portion of the battery plate. An epoxy can be dispensed robotically or by hand, such as forming lines or dots after being dispensed.

At 1208, the current collector (such as including the end contact bonded to the current collector) can be secured to a casing segment or end cap assembly. One or more channels or apertures can be defined in the casing to allow access to a protruding terminal, such as a terminal formed as a portion of the end contact.

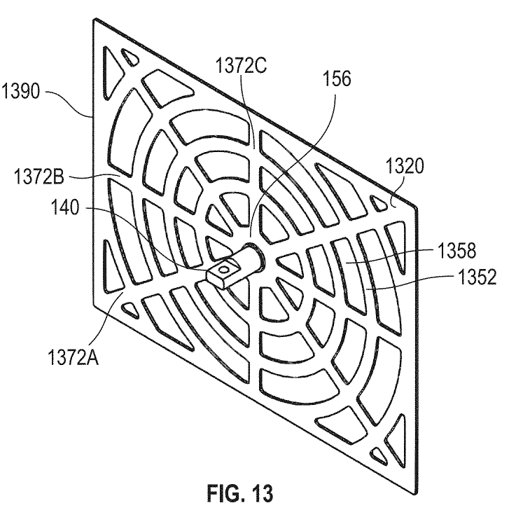

FIG. 13 illustrates generally an isometric view of an example including an electrical end contact 1320, such as can include a centrally-located hub region 156 and planar arms extending radially outward from the hub region 156. Such arms can include an arm 1372A extending outward diagonally, and other arms such as an arms 1372B and 1372C, extending horizontally and vertically in the plane of the end contact 1320, respectively. Concentric rings can be established, with radii extending outward radially from the central hub, and segments such as a brace segment 1352 can define such concentric rings as shown illustratively in FIG. 13.

Apertures can be defined by gaps between adjacent concentric rings and the planar arms, such as an aperture 1358. A region at the perimeter 1390 of the end contact 1320 can electrically and mechanically tie together portions of the planar arms 1372A, 1372B, 1372C and portions of the outer-most concentric rings. A resistance established by the contact 1320 of FIG. 13 is reduced as compared to other examples by increasing a count of planar arms (e.g., arms 1372A, 1372B, 1372C) radiating outward from the hub region 156 as compared to other examples. The end contact 1320 is also increased in this manner, such as supporting a higher compressive load and higher stress within the battery assembly.

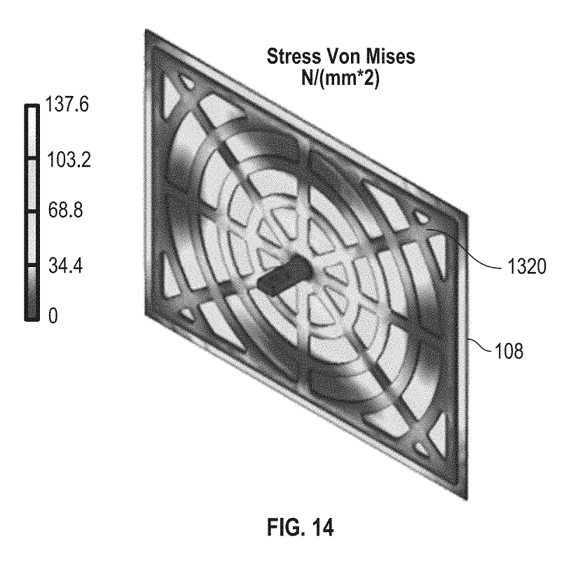

Acute angles between brace segments or “ribs” and adjacent planar arms can create challenges for fabrication of an end terminal. Such acute angles can also increase current density in an undesirable manner. Use of radiused brace segments such as the brace segment 1352 can help to address such fabrication challenges, such as enabling simpler manufacturing processes such as punching, which otherwise might generate stress concentrations that weaken punched structure. Use of the radiused brace segments can also help to reduce current “hot spots.” A current flow simulation of the concentric rib configuration shown illustratively in FIG. 13 resulted in a predicted resistance of less than 3 microOhms (μΩ), assuming a 24 Volt battery exhibiting an 18 Ampere discharge current. A further simulation of mechanical stress was performed, and FIG. 14 illustrates generally an illustrative example including such a stress simulation of an end contact when 120 kiloPascals (kPa) of simulated compressive force is applied to the end monopole assembly.

In the example of FIG. 14, the end contact 1320 is in contact with a battery plate that is loaded on one side by 360 pound-force (lbf) load, surrounding at its perimeter by a casing 108. As shown by the simulation of FIG. 14, a maximum estimated stress is less than about 137 MPa and a maximum displacement is about 0.86 mm. A trade-off may exist in the sense that while providing enhanced stiffness, the concentric rib arrangement for the end contact 1320 as shown in FIG. 13 and FIG. 14 does carry some penalty in terms of heavier weight as compared to other examples.

As mentioned above, through-system resistance is a technical challenge for battery manufacturers. The more resistance that a battery itself generates, the less capacity that battery can deliver and the less thermal stability the battery possesses. A quantity of active material and the resistance of the battery have often been inversely related in generally-available battery configurations. For example, higher capacity batteries often have more active material and thicker plates, both of which increase current paths and increase losses. As a result, in generally-available battery configurations, a tradeoff can exist between reasonable capacity and low resistance.

For the slow discharge rates corresponding to certain traction applications, such a trade-off has been acceptable and translated to cycle-life robustness because losses are generally minimized at medium-to-low currents. This same tradeoff is becoming less acceptable in applications related to modern power systems. Increasingly, energy storage applications demand high current discharge and recharge over short time scales. Capacity is still important, but power specifications are also important. Bipolar batteries can be generally well-suited for such modern challenges due to their simple electrical paths, but the present inventors have recognized, among other things, that terminating the battery stacks in an equally conductive manner has proven to be a challenge.

Specified characteristics for an end contact generally include mechanical strength, electrical conductivity, and low mass. Bipolar batteries generally operate most successfully under high mechanical compression (>60 kPa). In order for the current collectors to withstand such compression, the force is generally balanced on either side. For the end monopoles, the balance is generally provided at least in part using a rigid end contact that will not allow significant deformation of the monopole. Battery performance can be compromised with significant resistive drop on both ends of the series-connected stack. The cells can become imbalanced and overall life can be truncated. Low mass helps to maintain the high energy density advantage of bipolar batteries over monopolar configurations. The materials used for the end contact configurations described herein can include use of metals such as stainless steel, aluminum, or lead (for lead-acid batteries). However, carbon composites and other conductive engineered materials can also be used.

Regardless of contact method, the simplicity of the various end contact configurations described herein, and their lack of Z-axis complexity (e.g., features extending out-of-plane) makes such examples suitable for fabrication using a stamping process. Stamping is generally a high-throughput and low-cost manufacturing process and is widely used in most battery industries for other purposes, and can be adapted for end contact production. The terminals, whether protruding laterally (as shown in FIG. 1A) or vertically (as shown in FIG. 1B), could be welded onto the stamped product at low cost while maintaining good resistance characteristics. Terms such as lateral or vertical are merely descriptive of the views shown herein, and need not require that the terminals literally emerge horizontally or vertically in an absolute sense.

Bipolar batteries have the potential to address many of the modern energy storage industry's needs, the subject matter described herein provides a solution for low-resistance electrical termination for the series-connected stacks. In particular, the examples herein can be used to establish reasonable a compromise between mechanical strength, conductivity, and overall mass.

### Various Notes

Each of the non-limiting aspects described herein can stand on its own, or can be combined in various permutations or combinations with one or more of the other aspects or other subject matter described in this document.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of“at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. An electrically-conductive end contact for a bipolar battery, the end contact comprising:
a centrally-located hub region;
a plurality of planar arms extending distally from the centrally-located hub region; and
at least one planar brace comprising a first segment extending between two planar arms amongst the plurality of planar arms.

2. The electrically-conductive end contact of claim 1, wherein the plurality of planar arms define respective elongate apertures extending distally along the plurality of planar arms from the centrally-located hub region.

3. The electrically-conductive end contact of claim 1, wherein the at least one planar brace includes a second segment extending from the first segment to the centrally-located hub region.

4. The electrically-conductive end contact of claim 1, wherein the at least one planar brace is curved.

5. The electrically-conductive end contact of claim 4, wherein the at least one planar brace is amongst two or more concentrically-arranged planar brace segments defined by concentric rings.

6. The electrically-conductive end contact of claim 1, wherein the plurality of planar arms comprises at least four planar arms.

7. The electrically-conductive end contact of claim 6, comprising planar braces extending between respective adjacent pairs of the at least four planar arms.

8. The electrically-conductive end contact of claim 1, comprising a terminal located distally from the centrally-located hub region along an arm amongst the plurality of planar arms.

9. A method, comprising:
forming an electrically-conductive end contact comprising:
forming a centrally-located hub region;
forming a plurality of planar arms extending radially outward from the centrally-located hub region; and
forming at least one planar brace comprising a first segment extending between two planar arms amongst the plurality of planar arms.

10. The method of claim 9, wherein the forming comprises cold stamping the electrically-conductive end contact.

11. The method of claim 9, comprising forming a current collector; and
mechanically and electrically coupling the electrically-conductive end contact to the current collector.

12. The method of claim 11, comprising treating at least one surface of the current collector to provide an ohmic contact layer.

13. The method of claim 12, wherein the ohmic contact layer comprises a silicide.

14. The method of claim 11, comprising securing the current collector to a casing segment to provide a bipolar battery end plate assembly.

15. The method of claim 11, wherein the mechanically and electrically coupling the electrically-conductive end contact to the current collector comprises soldering the electrically-conductive end contact to the current collector.

16. The method of claim 15, wherein the soldering comprises reflowing a sheet of solder.

17. The method of claim 16, wherein the electrically-conductive end contact as placed upon the current collector, and the sheet is placed upon the electrically-conductive end contact prior to the reflowing.

18. The method of claim 11, wherein the mechanically and electrically coupling the electrically-conductive end contact to the current collector comprises adhering the electrically-conductive end contact to the current collector using a conductive adhesive.

19. A bipolar battery end plate assembly, comprising:
a current collector; and
an electrically-conductive end contact electrically coupled to the current collector, the electrically-conductive end contact comprising:
a centrally-located hub region;
a plurality of planar arms extending radially outward from a centrally-located hub region; and
at least one planar brace comprising a first segment extending between two planar arms amongst the plurality of planar arms.

20. The bipolar battery end plate assembly of claim 19, wherein the current collector comprises at least one surface including an ohmic contact layer.

21. The bipolar battery end plate assembly of claim 20, wherein the current collector comprises silicon, and wherein the ohmic contact layer comprises a silicide.

22. The bipolar battery end plate assembly of claim 19, comprising a casing portion; and
wherein the current collector is mechanically coupled to the casing portion.
